(19) United States
(12) Patent Application Publication
(10) Pub. No.: US 2023/0267267 A1
(43) Pub. Date: Aug. 24, 2023

(54) KNOWLEDGE DISCOVERY BASED ON USER-POSED QUERIES

(71) Applicant: NLMATICS CORP., New York, NY (US)

(72) Inventor: Ambika Sukla, Monroe Township, NJ (US)

(21) Appl. No.: 17/675,987

(22) Filed: Feb. 18, 2022

(51) Int. Cl. G06F 40/131; G06N 5/04; G06F 40/117; G06F 40/174

(52) U.S. Cl. CPC G06F 40/131; G06N 5/04; G06F 40/117; G06F 40/174

(57) ABSTRACT

Knowledge discovery can include deconstructing a content of a document into a set of text blocks; extracting from the text blocks an answer to a query posed by a user about the content of the document; and populating a column of a structured knowledge base with the answer.

### BACKGROUND

An individual researching a field of interest can obtain relevant information from relevant documents in the field. For example, an individual researching employment trends in publicly traded corporations can read through 10-K reports, quarterly reports, press releases, emails, etc., pertaining to such corporations. An individual can use computer-based search tools, e.g., keyword searches, to find information in such documents. An individual must often search through large numbers of such documents. Often such documents have a variety of different ways of organizing information which an individual must sift through.

### SUMMARY

In general, in one aspect, the invention relates to a knowledge discovery system based on user-posed queries. A knowledge discovery system according to the invention can include: a structured knowledge base having at least one column for holding a set of knowledge gleaned from a document; and a knowledge extractor that deconstructs a content of the document into a set of text blocks and that extracts from the text blocks an answer to a query about the content of the document posed by a user and then populates the column with the answer.

In general, in another aspect, the invention relates to a method for knowledge discovery based on user-posed queries. The method can include: deconstructing a content of a document into a set of text blocks; extracting from the text blocks an answer to a query posed by a user about the content of the document; and populating a column of a structured knowledge base with the answer.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a knowledge discovery system based on user-posed queries in one or more embodiments.

FIG. 2 shows an example of how a knowledge discovery system based on user-posed queries parses an example document into a set of text blocks by detecting a set of content indicators in the document.

FIG. 3-4 show examples of how a knowledge discovery system based on user-posed queries extracts an answer to a query posed by a user.

FIG. 5 shows how a knowledge discovery system based on user-posed queries populates a column of a structured knowledge base with answers to a query posed by a user that pertains to multiple documents.

FIG. 6 illustrates a user interface in one or more embodiments that enables a user to specify a set of search criteria along with a query.

FIG. 7 illustrates how in one or more embodiments a knowledge discovery system provides a user with an option for providing feedback pertaining to an answer to a user-posed query.

FIG. 8 shows a set of processing components of a knowledge extractor in one or more embodiments.

FIG. 9 illustrates a method for knowledge discovery based on user-posed queries in one or more embodiments.

FIG. 10 illustrates a computing system upon which portions of a knowledge discovery system based on user-posed queries can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

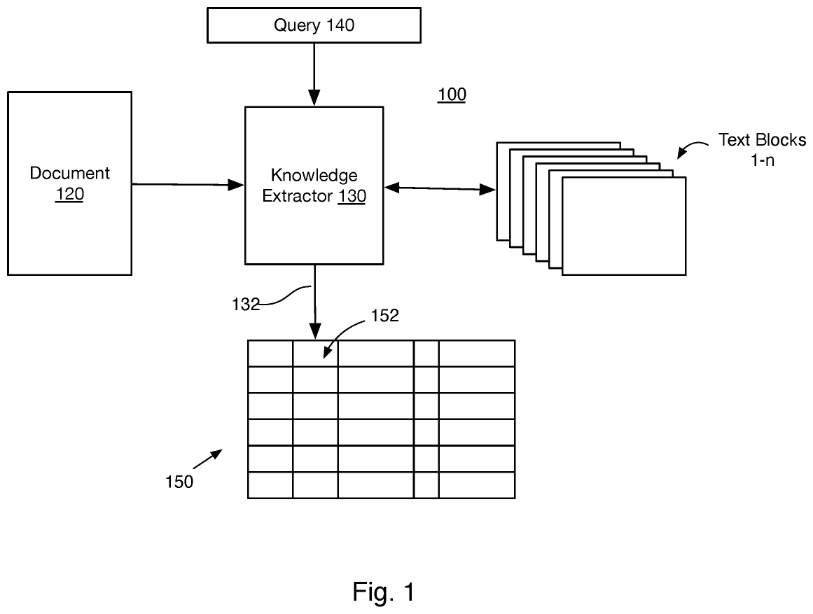

FIG. 1 illustrates a knowledge discovery system 100 based on user-posed queries in one or more embodiments. The knowledge discovery system 100 includes a structured knowledge base 150 having a set of columns, e.g., a column 152, for holding a set of knowledge gleaned from a document 120. The knowledge discovery system 100 includes a knowledge extractor 130 that deconstructs a content of the document 120 into a set of text blocks 1-n and that extracts from the text blocks 1-n an answer 132 to a query 140 about the content of the document 120 posed by a user and then populates the column 152 with the answer 132.

The document 120 can be any type of document containing information of interest to a user of the knowledge discovery system 100. Examples include PDF documents, word processing documents, spreadsheets, image documents, etc.

The document 120 can encompass any area of interest to a user of the knowledge discovery system 100. Examples include law, e.g., employment contracts, non-disclosure agreements, real-estate sales memoranda, etc., finance, e.g., corporate finance, bond markets, banking, etc., medicine, e.g., clinical trials, drug efficacy, etc., to name just a few examples.

Examples of the structured knowledge base 150 include databases and spreadsheets. In one or more embodiments, a user of the knowledge discovery system 100 poses a series of queries about the content of the document 120 and the knowledge extractor 130 extracts an answer to each query in the series from the deconstructed text blocks 1-n and fills columns of the structured knowledge base 150 with the answers.

In one or more embodiments, the knowledge extractor 130 deconstructs the content of the document 120 by recognizing at least one content indicator in the document 120. Examples of content indicators include document headers, section headers, subsection headers, etc. In one or more embodiments, the knowledge extractor 130 recognizes the content indicators by recognizing formatting features in the document 120, e.g., placement of text on a page, e.g., large text centered on a page, large text justified above a block of regular text, font size, attributes such as bold, underline, etc., indicating how content is organized, section numbering of various kinds combined with header text, etc. The knowledge extractor 130 in some embodiments recognizes the content indicators in the document 120 using a set of heuristics regarding layouts commonly found in documents. In other embodiments, the knowledge extractor 130 uses a neural network trained to recognize content indicators, or a combination of heuristics and neural networks.

In one or more embodiments, the knowledge extractor 130 extracts the answer 132 by matching the query 140 to the text blocks 1-n using natural language processing. For example, a natural language processing analysis of “What was the net profit for FY 2020” indicates a user seeks a numerical value from the text blocks 1-n that pertain to profit. In another example, a natural language processing analysis of “does the company have a net-zero emissions target” indicates a user seeks a yes/no answer from the text blocks 1-n that pertain to environmental impacts/sustainability.

The query 140 in one or more embodiments includes one or more questions pertaining to the document 120 posed by a user. In some embodiments, the query 140 includes a set of hints pertaining to the question(s) posed by the user. Examples of hints include a hint to look for an answer to the query 140 only in the first x pages of the document 120, a hint to look for an answer to the query 140 only in text that includes a list of keywords specified in the hint.

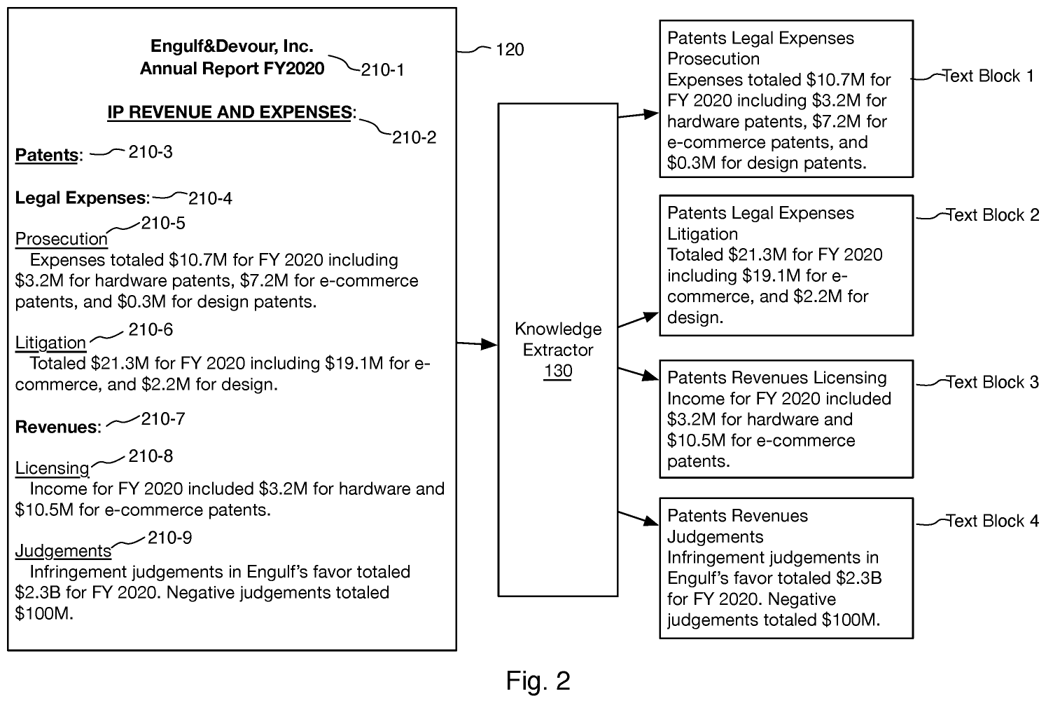

FIG. 2 shows an example of how the knowledge extractor 130 parses an example of the document 120 into a set of text blocks 1 through 4 by detecting a set of content indicators 210-1 through 210-9 in the document 120. In this example, the document 120 is entitled “Engulf&Devour, Inc. Annual Report FY2020 IP REVENUE AND EXPENSES” which the knowledge extractor 130 recognizes as the content indicators 210-1 and 210-2.

The knowledge extractor 130 recognizes a hierarchical tree structure in the content indicators 210-1 through 210-9 with the content indicator 210-3 (“Patents”) at the top, branches at the content indicators 210-4 (“Legal Expenses”) and 210-7″ “(Revenues”), and subbranches of the content indicator 210-4 (“Legal Expenses”) at the content indicators 210-5 (“Prosecution”) and 210-6 (“Litigation”) and subbranches of content indicator 210-7″ (“Revenues”) at the content indicators 210-8 (“Licensing”) and 210-9 (“Judgements”).

The knowledge extractor 130 associates the text block 1 with the text at the bottom of the “Patents” “Legal Expenses” “Prosecution” hierarchical path of the content indicators 210-3 through 210-9. The knowledge extractor 130 associates the text block 2 with the text at the bottom of the “Patents” “Legal Expenses” “Litigation” hierarchical path of the content indicators 210-3 through 210-9. The knowledge extractor 130 associates the text block 3 with the text at the bottom of the “Patents” “Revenues” “Licensing” hierarchical path of the content indicators 210-3 through 210-9 and the text block 4 with the text at the bottom of the “Patents” “Revenues” “Judgements” hierarchical path of the content indicators 210-3 through 210-9.

In one or more embodiments, the knowledge extractor 130 detects the content indicators 210-1 through 210-9 by detecting the placement and formatting of document navigation features in the document 120 and applying heuristics to the detected placements. For example, the bold and underline attributes of “Patents:” indicates a feature higher in position in a text block hierarchy than the bold attribute of “Legal Expenses” which, in turn indicates a higher position in a text block hierarchy over the underline attributes of “Prosecution” and “Litigation”. Header numbering schemes, section numbering schemes, etc., on documents can also indicate hierarchical content structure to the knowledge extractor 130.

In one or more other embodiments, the knowledge extractor 130 detects the content indicators 210-1 through 210-9 by applying machine learning, e.g., by training a neural network to recognize pixel patterns in the document 120 that are indicative of the text blocks 1-n. The knowledge extractor 130 in some embodiments detects the content indicators 210-1 through 210-9 by applying a combination of heuristics and machine learning.

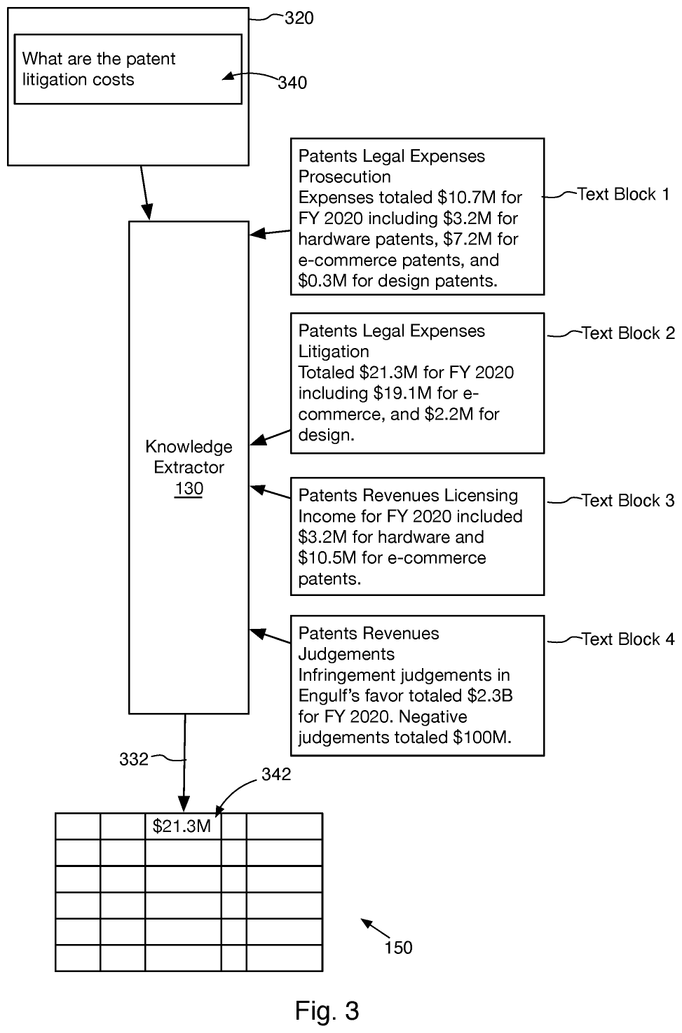

FIG. 3 shows how the knowledge extractor 130 extracts from the text blocks 1 through 4 an answer 332 to a query 340 (“What are the patent litigation costs”) posed by a user via a user interface 320 of the knowledge discovery system 100. The knowledge extractor 130 in one or more embodiments uses natural language processing to associate “patent litigation costs” from the query 340 to the “Patents Legal Expenses Litigation” label of the text block 2 and extracts the “Totaled” value of “21.3 M” from the text block 2 as the answer 332 to the query 340 and stores the answer 332 in a column 342 of the structured knowledge base 150.

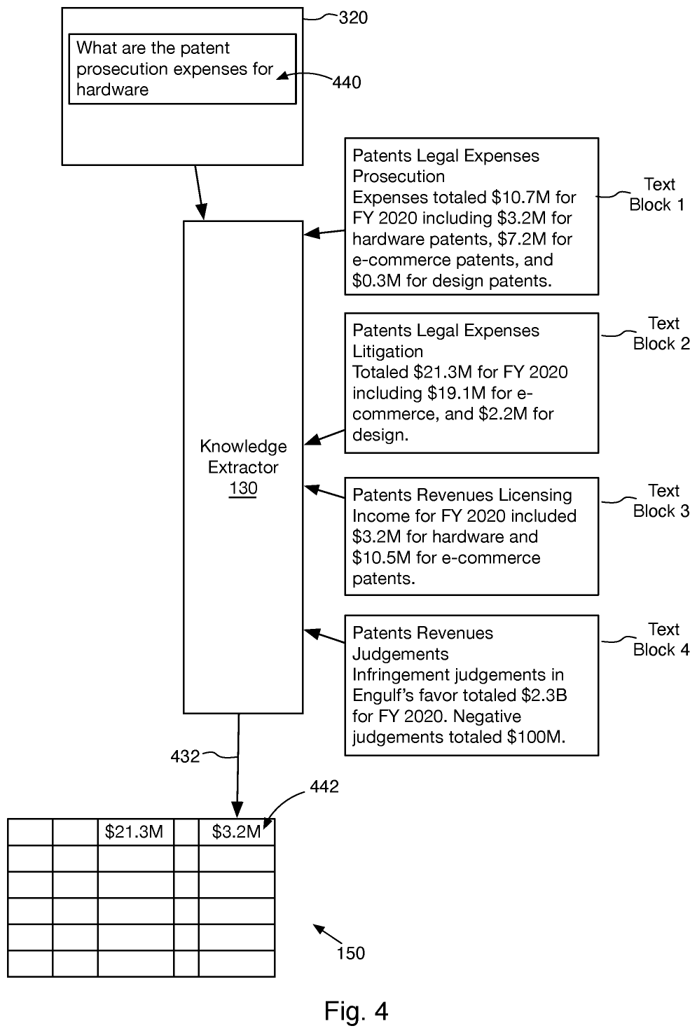

FIG. 4 shows how the knowledge extractor 130 extracts an answer 432 from the text blocks 1 through 4 to a query 440 (“What are the patent prosecution expenses for hardware”) posed by a user. The knowledge extractor 130 uses natural language processing to associate “patent prosecution expenses for hardware” from the query 440 to the “Patents Legal Expenses Prosecution” label of the text block 1 and extracts the “Totaled” value of “3.2 M” “for hardware” from the text block 1 as the answer 432 and stores the answer 432 “3.2 M” in a column 442 of the structured knowledge base 150.

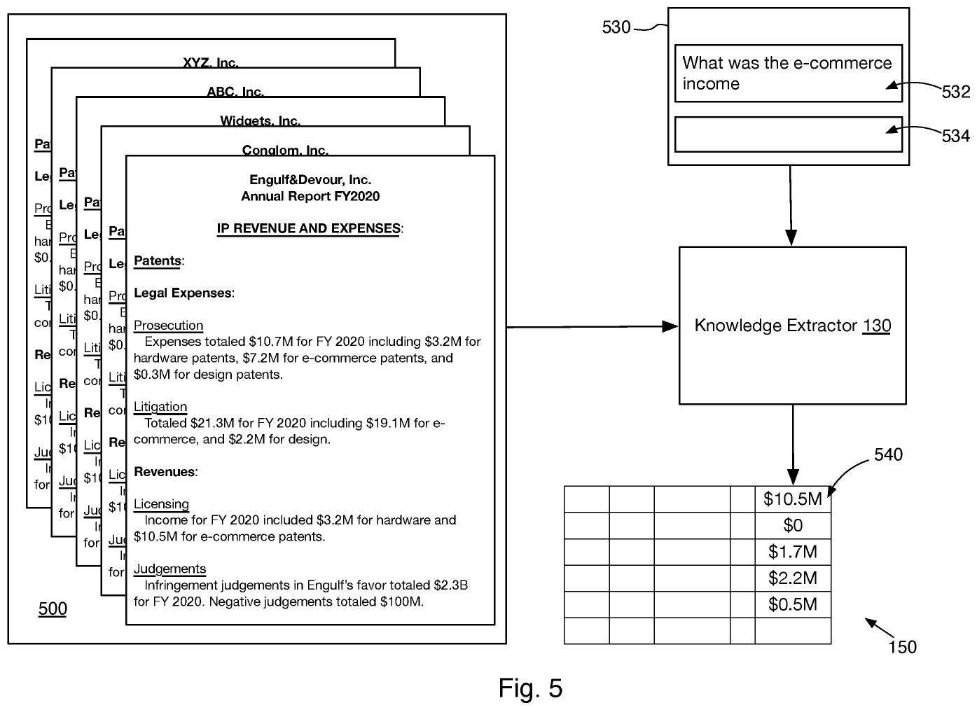

FIG. 5 shows how the knowledge extractor 130 populates a column 540 of the structured knowledge base 150 with answers to a query 532 (“What was the e-commerce income”) posed by a user via a user interface 530 and targeting a workspace 500 holding a set of five documents which are all IP Revenue/Expense reports but for five different corporations. The knowledge extractor 130 extracts five different answers, $10.5 M, $0, $1.7 M, $2.2 M, $0.5 M, from the five different documents 1-5 to populate the column 540 by parsing each document in the workspace 500 independently and then applying the query 532 to each using natural language processing.

In one or more embodiments, the user interface 530 of the knowledge discovery system 100 includes fields that enable a user to specify one or more hints, e.g., a hint 534, for answering a query posed. Examples of the hint 534 include a hint to look for an answer to the query 532 only in the first x pages of each document in the workspace 500, a hint to look for an answer to the query 534 only in text that includes a list of keywords specified in the hint 534.

The knowledge discovery system 100 can be used by any user to discover and organize information in any field of interest by assembling a collection of pertinent documents in a workspace of the knowledge discovery system 100 and then posing pertinent queries of interest via a user interface of the knowledge discovery system 100. For example, a user researching employment in the auto industry can assemble documents pertaining to the auto industry, e.g., corporate reports, consumer reports, news stories, etc., and then pose queries, e.g., “How many are employed in California” or “What percentage of employees are women”, etc., and then use the answers in the structured knowledge base 150 to discern industry trends, predict future events, etc. In another example, a user seeking to survey clinical trials can assemble a collection of clinical trial reports and ask, e.g., “How many trials are associated with a university” or “What was the percentage of serious side effects”, “What was the percentage of Hispanics in the study”, etc.

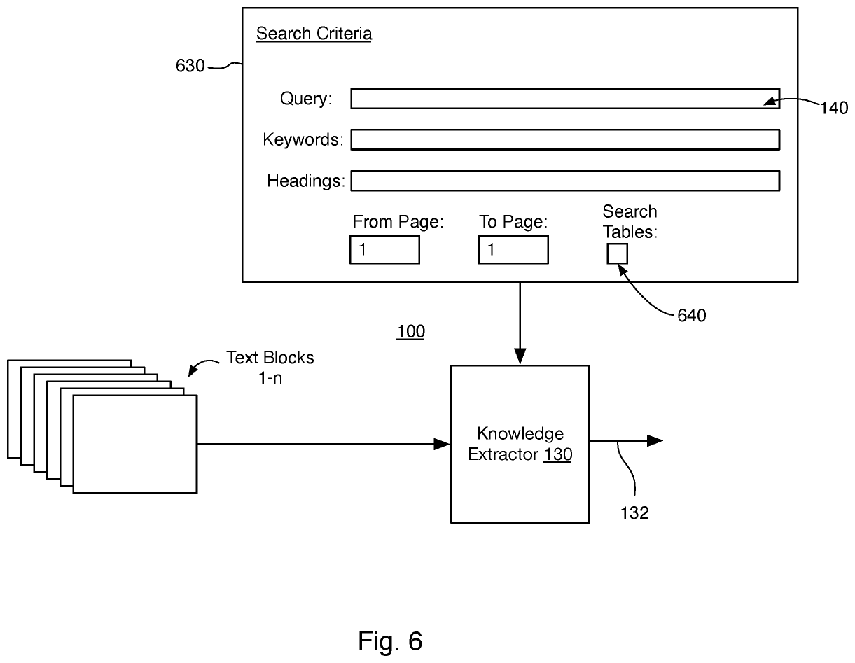

FIG. 6 illustrates an embodiment of the knowledge discovery system 100 that generates a user interface 630 that enables a user to specify a set of search criteria along with the query 140 posed by a user. In this embodiment, the search criteria can include any combination of the query 140, one or more keywords for finding the answer 132, and hints that include identifications of headings to search in, a page range in the document 120, and a checkbox 640 indicating whether or not to search in any tables contained in the document 120.

For example, a query posed for a clinical trial report of “what was the efficacy for under 20-year-olds” can include the keyword “phase 2” or the heading “phase 2 results” if a user is only interested in results for under 20 year-olds in phase 2. If a user knows that for clinical trial reports the sought-after information is always near the beginning of the report an appropriate page range can be specified in the user interface 630.

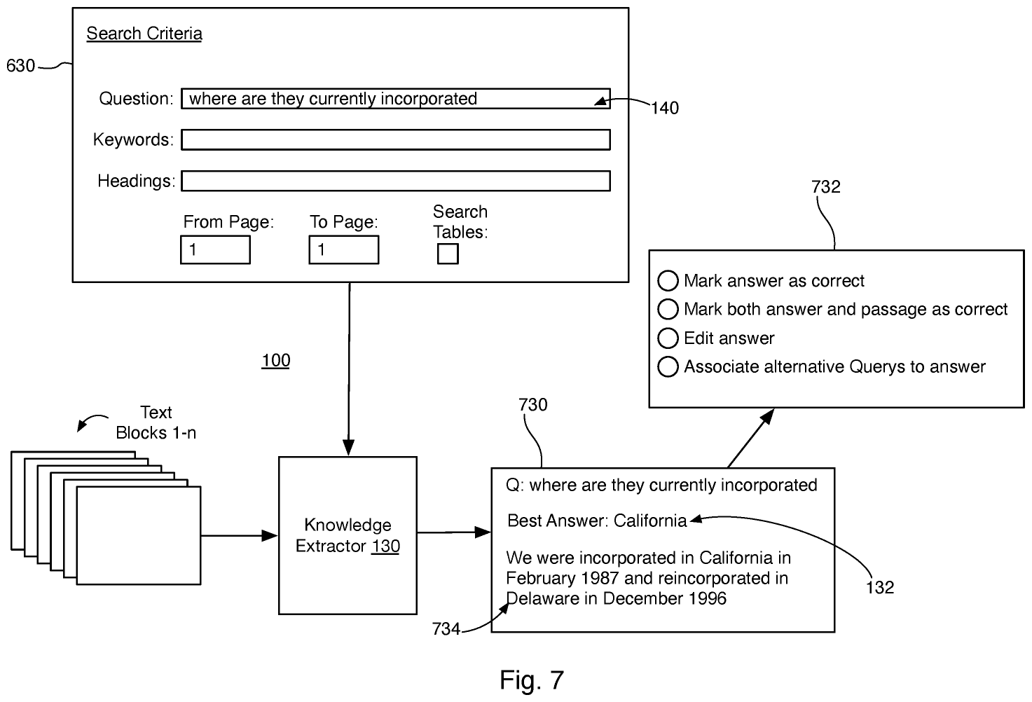

FIG. 7 illustrates how in one or more embodiments the knowledge discovery system 100 provides a user with an option for providing feedback pertaining to the answer 132 rendered by the knowledge extractor 130. In this example, the knowledge discovery system 100 generates a user interface 730 displaying the answer 132 (“California”) to the query 140 (“where are they currently incorporated”) posed by a user along with a passage 734 from the text blocks 1-n from which the answer 132 was extracted. The knowledge discovery system 100 also generates a user interface 732, e.g., a popup, with a set of training options available for selection by a user.

The user interface 732 includes an option for the user to mark the answer 132 as correct. A selection of the answer is correct option can be used as additional data for refining the knowledge extractor 130, e.g., training data for a classifier, e.g., a neural network, data for updating heuristic rules, etc.

The user interface 732 includes an option for the user to mark the answer 132 and the passage 734 as correct. The combination of the answer 132 and the passage 734 can be used as additional data for refining the knowledge extractor 130 when a user selects this option.

The user interface 732 includes an option for the user to edit the answer 132, e.g., by selecting “Delaware” in the passage 734 as the correct answer to the query 140. The selected correct answer can be used as additional data for refining the knowledge extractor 130 when a user selects this option.

The user interface 732 includes an option for the user to associate one or more alternative queries to the answer 132. In one or more embodiments, the knowledge discovery system 100 prompts the user for an alternative query, e.g., “where were they originally incorporated”, to the answer 132 “California”. The knowledge discovery system 100 uses the alternative answer as data for refining the knowledge extractor 130.

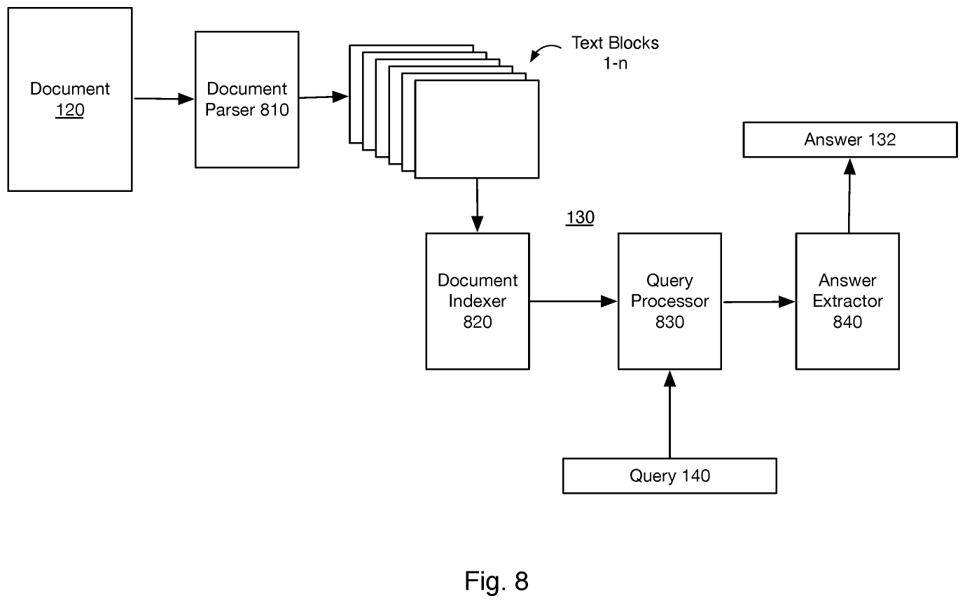

FIG. 8 shows a set of processing components of the knowledge extractor 130 in one or more embodiments. The knowledge extractor 130 in one or more embodiments includes a document parser 810, a document indexer 820, a query processor 830, and an answer extractor 840.

The document parser 810 breaks the document 120 into the text blocks 1-n that facilitate accurate document indexing and query processing. The document parser 810 parses the document 120, e.g., a PDF, a DOC or n HTML document, line by line and arranges it into the text blocks 1-n. Examples of the text blocks 1-n in one or more embodiments include paragraphs, lists, section headings, tables, etc.

In one or more embodiments, the document parser 810 determines types for the text blocks 1-n using a set of heuristics and deep learning based computer vision image segmentation models. The document parser 810 detects a type of a text block even absent an explicit tag in the document 120 identifying a type of the text block. For example, a paragraph may be broken down into a set of disjoint lines in the document 120 and the document parser 810 detects the boundaries such that a beginning and an end of paragraph can be used to collect all text that belongs to a paragraph block.

In one or more embodiments, the document parser 810 detects and removes repeating text blocks, e.g., page headers, page footers, page numbers, etc., so that paragraphs, lists and tables can be joined across pages.

In one or more embodiments, the document parser 810 detects indentation of text blocks, spacing between text blocks, font style of text blocks and lexical elements of the text blocks to determine relative hierarchy of the text blocks 1-n. For example, a line of text with font larger than the average font size of the document 120 and not ending with periods is a possible section heading, another line of text following such a line but having smaller font size or a different font style or a new numbering sequence is possibly a sub heading if it is short, doesn't end with a period and has first letter of most words capitalized.

In one or more embodiments, the deep learning based image segmentation models are trained using an image representation of the page as input and expected boundaries as output. Image segmentation and object detection models that work better with rectangular objects are selected as page blocks are rectangular and have no overlap. For example, Yolo is preferred to a technique such as R-CNN. No overlapping of object boundaries proposed by model is used as a constraint in loss function to train deep learning models. Initial labels for the deep learning models are generated by heuristics. For example, heuristics make best effort detection of table boundaries on a page. Table boundaries detected by heuristics can be manually adjusted as necessary in the user interface before training. A simplified black and white picture of a page is created as input to substantially speed up detection. The picture consists of a black background with several white rectangles, where each rectangle represents boundaries of a word in the page.

The document indexer 820 indexes each text block 1-n sentence by sentence for retrieval based on keywords, similar words, type of entity, words in quotes, and words in surrounding paragraph and parent section headings or section subheadings. For an example sentence “This Master Service Agreement (“Agreement”) is entered into on Feb. 11, 2022 between XYZ Inc., a Delaware Corporation (“Customer”) and ABC Corp., a Washington Corporation (“Provider”)” the document indexer 820 applies natural language processing and name entity recognition to identify Feb. 11, 2022 as a DATE, XYZ Inc and ABC Corp. as ORGANIZATION and Delaware and Washington as STATES with the following attributes: keyword attribute consisting of all keywords except stop words such as XYZ and ABC; quoted words attributed consisting of words “Agreement”, “Customer” and “Provider” which are in quotes; answer type attribute consisting of DATE, ORGANIZATION and STATE.

In the following example hierarchy:

“11. Termination

11.1 Change of Control. This agreement can be terminated due to bankruptcy or insolvency of either party.”

In addition to the attributes used in the above example, another attribute called header hierarchy is used having values “change control” and “termination”.

In the case of a list, the parent sentence is also indexed. For example, in the text block:

“This investment involves following risks:

Environmental risks

Insolvency risks

Regulatory risks”

Each list item such as environmental risk is also indexed with an additional attribute parent text consisting of the words in the sentence “This investment involves following risks”.

Surrounding words from paragraph of a sentence are also indexed in an attribute called block text. In the example “ABC Corp. has exceeded analyst expectations in the last quarter. The company's new product XYZ has been received well. International sales has been another contributor to it's revenue” when the second sentence is indexed, the block text attribute consists of words from first and third sentence such as: ABC Corp., exceeded, analyst, last, quarter, international, sales.

Tables are indexed as rows, columns and cells. For an example table:

| | Q1 | Q2 |
|---|---|---|
| Revenue | 20M | 30M |
| Expenses | 2M | 3M |

The following indexable text blocks are created from the table:

“Revenue”->entire revenue row

“Expenses”->entire expenses row

“Q1”->entire Q1 column

“Q2”->entire Q2 column

“Q1 Revenue”->20 M

“Q2 Revenue”->30 M

“Q1 Expenses”->2 M

“Q2 Expenses”->3 M

Words in the above sentences are stored in the keywords attribute of the index. The attribute header hierarchy is added when the table is under section heading or subheading.

The document indexer 820 creates a vector of decimals of size 300 or more with different embedding methods to ensure that correct sentences are retrieved in response to a query even when there is limited overlap in keywords. A vector of decimals, called sentence embedding is a signature or location of the sentence in a multi dimensional space, each dimension being represented by the corresponding decimal in the vector. SIF and DPR embeddings are used, but the document indexer 820 allows provision to add other embeddings. A sentence such as “we”, “our”, “us” or “the Company” are referred to as ABC Inc. would yield:

SIF Embedding: [0.3, 0.78, 0.46] 300 dimensions

DPR Embedding: [0.1, 0.24, . . . , 0.46] 1024 dimensions

The query processor 830 matches the query 140 to the document 120 to retrieve the best set of sentences or passages for extracting the answer 132. The query processor 830 matches the query 140 with the text blocks 1-n using the attributes created for each text block 1-n. The attributes are keywords, quoted words, answer type, header hierarchy, parent text, block text, sif embedding and dpr embedding.

The query processor 830 breaks the query 140 down into keywords, and uses a deep learning model to predict the answer type of the query 140 and creates sif/dpr embedding for the query 140. An example the query 140 is “How much is the principal aggregate amount?” in which, before searching for passages, the query processor 830 breaks it down into its attributes keywords: much, principal, aggregate, amount. Answer Type: money. Sif embedding and DPR embedding are also calculated. For the purpose of matching and ranking, keywords in the query 140 are matched with keywords, quoted words, header hierarchy, parent text and block text of each indexed sentence, and embeddings of the query 140 sif embedding and dpr embedding are matched with each sentence's embedding using cosine similarity, and answer type of the embedding is matched with possible answer types in each sentence.

A shallow neural network based machine learning model is trained with several thousand queries, a list of passages as input and the ranking of passages as probable answers as output. The machine learning model learns relative weightage of attributes to use for passage selection based on the query 140.

To process the query 140, best passages are retrieved by matching the query 140 with attributes, assigning a score to the match and using weights derived from the query 140 breakdown to assign a total score to the selection.

When the query 140 is without hints, the query processor 830 makes best effort to match with all attributes in the indexed text blocks. A user can more accurately control this behavior by limiting the search to page ranges, text blocks having exact keywords or ask the system to prefer searching under certain sections. Users can create one or more of such criteria via the query 140.

The answer extractor 840 selects the top, e.g., 20, passages identified by the query processor 830 for extracting the answer 132. Queries prompting a yes or no answer are processed by a BERT based deep learning language model trained for entailment task. Entailment model takes one sentence and a paragraph and predicts if the semantic message in the sentence is contained within the paragraph. Yes/No questions are rephrased as sentences to work with the entailment model. For example “are the bonds convertible” is rephrased as “the bonds are convertible” before sending to entailment model. Queries expecting any answer other than yes or no are processed by a BERT based deep learning reading comprehension model. A reading comprehension model is trained with a paragraph and question as input to find an answer from the paragraph. Data created by the feedback loop is used for incremental training of the model. Once a model is trained with feedback data from users, the model doesn't make the corresponding mistakes going forward.

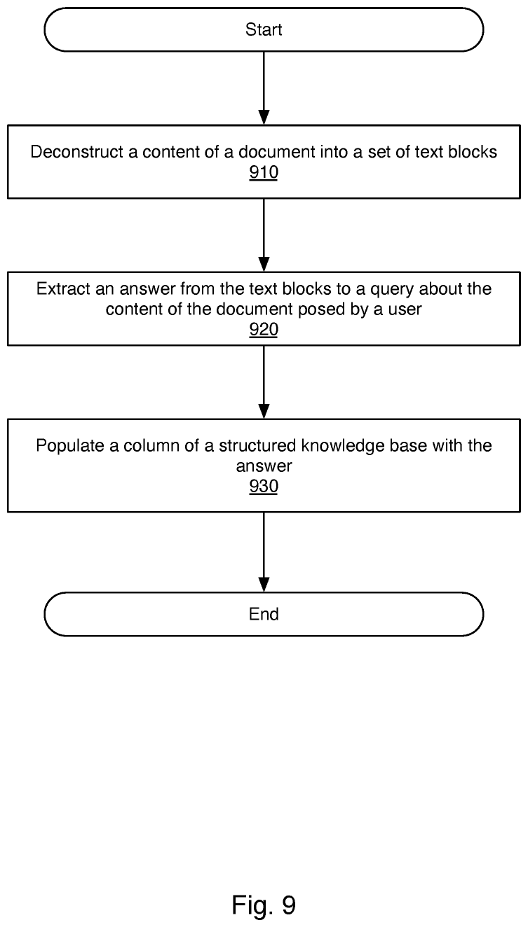

FIG. 9 illustrates a method for knowledge discovery in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 9 should not be construed as limiting the scope of the invention.

At step 910, a content of a document is deconstructed into a set of text blocks. Deconstruction can include recognizing features in the document that convey content arrangement of the document. Recognition can be based on document formatting, numbering schemes, arrangements of document titles, sub-titles, section titles, etc.

At step 920, an answer is extracted from the text blocks to a query about the content of the document posed by a user. The answer can be extracted using natural language processing. The answer can be extracted in accordance with one or more hints provided by the user along with the query.

At step 930, a column of a structured knowledge base is populated with the answer extracted from the deconstructed text blocks. The structured knowledge base can be a database, a spreadsheet, etc.

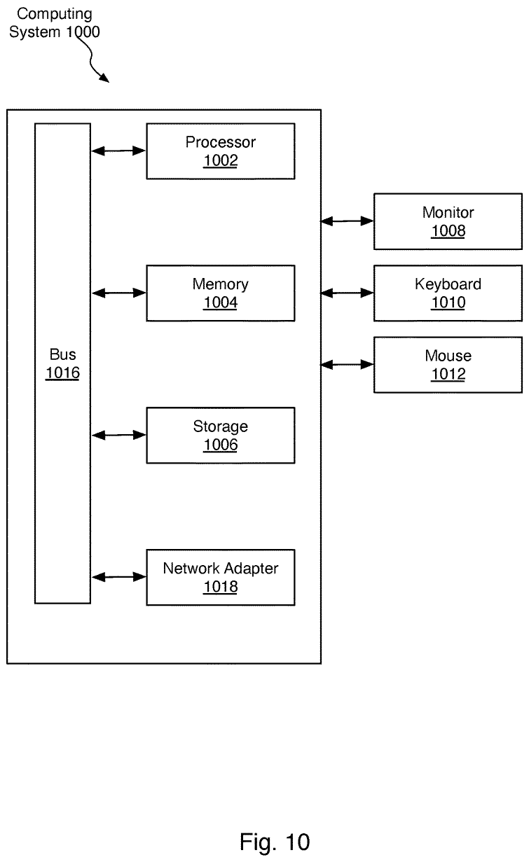

FIG. 10 illustrates a computing system 1000 upon which portions of the knowledge discovery system 100 can be implemented. The computing system 1000 includes one or more computer processor(s) 1002, associated memory 1004 (e.g., random access memory (RAM), cache memory, flash memory, etc.), one or more storage device(s) 1006 (e.g., a hard disk, an optical drive such as a compact disk (CD) drive or digital versatile disk (DVD) drive, a flash memory stick, etc.), a bus 1016, and numerous other elements and functionalities. The computer processor(s) 1002 may be an integrated circuit for processing instructions. For example, the computer processor(s) may be one or more cores or micro-cores of a processor. The computing system 1000 may also include one or more input device(s), e.g., a touchscreen, keyboard 1010, mouse 1012, microphone, touchpad, electronic pen, or any other type of input device. Further, the computing system 1000 may include one or more monitor device(s) 1008, such as a screen (e.g., a liquid crystal display (LCD), a plasma display, touchscreen, cathode ray tube (CRT) monitor, projector, or other display device), external storage, input for an electric instrument, or any other output device. The computing system 1000 may be connected to a network (e.g., a local area network (LAN), a wide area network (WAN) such as the Internet, mobile network, or any other type of network) via a network adapter 1018.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A knowledge discovery system, comprising:
a structured knowledge base having at least one column for holding a set of knowledge gleaned from a document; and
a knowledge extractor that deconstructs a content of the document into a set of text blocks and that extracts an answer from the text blocks to a query posed by a user pertaining to the content of the document and then populates the column with the answer.

2. The knowledge discovery system of claim 1, wherein the knowledge extractor deconstructs the content by recognizing at least one content indicator in the document.

3. The knowledge discovery system of claim 2, wherein the knowledge extractor recognizes the content indicator by recognizing at least one formatting feature of the document.

4. The knowledge discovery system of claim 1, wherein the knowledge extractor extracts the answer by matching the query to the text blocks using natural language processing.

5. The knowledge discovery system of claim 4, wherein the knowledge extractor extracts the answer in response to at least one hint specified by the user.

6. The knowledge discovery system of claim 1, wherein the document is one of a plurality of documents in a workspace of the knowledge discovery system such that the knowledge extractor extracts a respective answer to the query from each document in the workspace and then populates the column of the structured knowledge base with the answers.

7. The knowledge discovery system of claim 1, further comprising a user interface that enables the user to specify a set of search criteria in the query including one or more hints pertaining to where in the document to look for the answer.

8. The knowledge discovery system of claim 1, further comprising a user interface that enables the user to provide a feedback pertaining to the answer such that the knowledge extractor includes a neural network that is retrained in response to the feedback.

9. A method for knowledge discovery, comprising:
deconstructing a content of a document into a set of text blocks;
extracting from the text blocks an answer to a query posed by a user about the content of the document; and
populating a column of a structured knowledge base with the answer.

10. The method of claim 9, wherein deconstructing comprises recognizing at least one content indicator in the document.

11. The method of claim 10, wherein recognizing comprises recognizing at least one formatting feature of the document.

12. The method of claim 9, wherein extracting comprises matching the query to the text blocks using natural language processing.

13. The method of claim 12, wherein extracting comprises extracting the answer in response to at least one hint specified by the user.

14. The method of claim 9, further comprising gathering a plurality of documents into a workspace and extracting a respective answer to the query from each document in the workspace and then populating the column of the structured knowledge base with the answers.

15. The method of claim 9, further comprising generating a user interface that enables the user to specify a set of search criteria for the query including one or more hints pertaining to where in the document to look for the answer.

16. The method of claim 9, further comprising generating a user interface that enables the user to provide a feedback pertaining to the answer and training a neural network in response to the feedback.
